(19) United States
(12) Patent Application Publication
(10) Pub. No.: US 2019/0322317 A1
(43) Pub. Date: Oct. 24, 2019

(54) SYSTEM AND METHOD FOR AUTOMATICALLY DETERMINING DIMENSIONS OF A TRAILER

(71) Applicant: GM Global Technology Operations LLC, Detroit, MI (US)

(72) Inventors: Sepehr POURREZAEI KHALIGH, Markham (CA); Hasan Alper HEPGUVENDIK, Toronto (CA); Akram M. ABDEL-RAHMAN, Ajax (CA); Azadeh FARAZANDEH, Thornhill (CA); Sanjay K. SHAKYAVER, Toronto (CA)

(73) Assignee: GM Global Technology Operations LLC, Detroit, MI (US)

(21) Appl. No.: 15/955,739

(22) Filed: Apr. 18, 2018

(51) Int. Cl. B62D 13/02; B62D 13/06; B62D 59/02; B60W 40/105; G01M 17/06; G01P 3/04

(52) U.S. Cl. CPC B62D 13/025; B62D 13/06; G01P 3/04; B60W 40/105; G01M 17/06; B62D 59/02

(57) ABSTRACT

A hitch angle module determines a hitch angle based on an input from at least one of a vehicle rear camera and a hitch angle sensor. The hitch angle is an angle between a longitudinal centerline of a trailer and a longitudinal centerline of a vehicle. A trailer load sensor measures a load on a trailer hitch of the vehicle. A trailer wheel speed sensor measures a wheel speed of the trailer. A trailer dimension module determines at least one of a width of the trailer, a mass of the trailer, a drawbar length of the trailer, a height of the trailer, and a trailer hitching length of the vehicle based on at least one of the hitch angle, the trailer load, and the trailer wheel speed. The trailer hitching length is a distance from a rear axle of the vehicle to a distal end of the trailer hitch.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for automatically determining dimensions of a trailer.

Some driver assistance systems determine an expected trajectory of a trailer when providing assistance to a driver of a vehicle towing the trailer. In some vehicles, the expected trajectory of a trailer is represented by a pair of lines or curves displayed on an electronic device in view of the driver to assist the driver in deciding how to steer the vehicle. Similarly, some autonomous driving systems determine an expected trajectory of a trailer when deciding how to steer a vehicle towing the trailer in order to keep the vehicle and the trailer within the boundaries of a lane.

Various dimensions of a trailer affect the dynamic behavior of the trailer and therefore are typically used to determine the expected trajectory of the trailer. These dimensions include the drawbar length of the trailer, the total length of the trailer, the width of the trailer, the height of the trailer, and the mass of the trailer. In some cases, the trailer hitching length of a vehicle is also used to determine the expected trajectory of a trailer towed by the vehicle. The trailer hitching length of a vehicle is the distance from a rear axle of the vehicle to the ball of a trailer hitch on the vehicle.

### SUMMARY

A system according to the present disclosure includes a trailer dimension module and at least one of a hitch angle module, a trailer load sensor, and a trailer wheel speed sensor. The hitch angle module is configured to determine a hitch angle based on an input from at least one of a rear camera of a vehicle and a hitch angle sensor. The hitch angle is an angle between a longitudinal centerline of a trailer and a longitudinal centerline of the vehicle. The trailer load sensor is configured to measure a load applied by the trailer on a trailer hitch of the vehicle. The trailer wheel speed sensor is configured to measure a wheel speed of the trailer. The trailer dimension module is configured to determine at least one of a width of the trailer, a mass of the trailer, a drawbar length of the trailer, a height of the trailer, and a trailer hitching length of the vehicle based on at least one of the hitch angle, the trailer load, and the trailer wheel speed. The trailer hitching length is a distance from a rear axle of the vehicle to a distal end of the trailer hitch.

In one example, the system includes the hitch angle module and the trailer load sensor, and the trailer dimension module is configured to determine the trailer width and the trailer mass based on the hitch angle and the trailer load using a mathematical model and non-linear regression.

In one example, the trailer dimension module is configured to determine the trailer width and the trailer mass further based on a second derivative of the hitch angle with respect to time, a longitudinal acceleration of the vehicle, a wheelbase of the vehicle, and a steering angle of the vehicle.

In one example, the system includes the trailer wheel speed sensor, and the trailer dimension module is configured to determine the trailer width based on the trailer wheel speed using a kinematic model.

In one example, the system further includes a trailer turning radius module configured to determine a turning radius of the trailer based on a wheelbase of the vehicle, a steering angle of the vehicle, the trailer hitching length, and the trailer drawbar length, and the trailer dimension module is configured to determine the trailer width further based on the trailer turning radius.

In one example, the system includes the hitch angle module, and the trailer dimension module is configured to determine the trailer drawbar length and the trailer hitching length based on the hitch angle using a kinematic model and linear regression.

In one example, the trailer dimension module is configured to determine the trailer drawbar length and the trailer hitching length further based on a speed of the vehicle, a first derivative of the hitch angle with respect to time, a wheelbase of the vehicle, and a steering angle of the vehicle.

In one example, the system further includes at least one of a steering control module and a user interface device (UID) control module. The steering control module is configured to control a steering actuator of the vehicle based on the trailer width. The UID control module is configured to control a user interface device of the vehicle based on at least one of the trailer width, the trailer mass, the trailer drawbar length, the trailer height, and the trailer hitching length.

Another system according to the present disclosure includes a trailer dimension module and a vehicle-to-vehicle (V2V) transceiver. The trailer dimension module is configured to determine at least one of a width of a trailer towed by a first vehicle, a length of the trailer, and a height of the trailer based on an image of the trailer generated by a camera mounted to a second vehicle. The V2V transceiver is configured to transmit at least one of the trailer width, the trailer length, the trailer height, and the trailer image to the first vehicle.

In one example, the trailer dimension module is located on the first vehicle, and the V2V transceiver is configured to transmit the trailer image to the first vehicle.

A method according to the present disclosure includes at least one of (i) determining a hitch angle based on an input from at least one of a rear camera of a vehicle and a hitch angle sensor, (ii) measuring a load applied by the trailer on a trailer hitch of the vehicle, and (iii) measuring a wheel speed of the trailer. The hitch angle is an angle between a longitudinal centerline of a trailer and a longitudinal centerline of the vehicle. The method further includes determining at least one of a width of the trailer, a mass of the trailer, a drawbar length of the trailer, a height of the trailer, and a trailer hitching length of the vehicle based on at least one of the hitch angle, the trailer load, and the trailer wheel speed. The trailer hitching length is a distance from a rear axle of the vehicle to a distal end of the trailer hitch.

In one example, the method includes determining the hitch angle based on the input from the at least one of the rear camera of the vehicle and the hitch angle sensor, and determining the trailer width and the trailer mass based on the hitch angle and the trailer load using a mathematical model and non-linear regression.

In another example, the method includes determining the trailer width and the trailer mass further based on a second derivative of the hitch angle with respect to time, a longitudinal acceleration of the vehicle, a wheelbase of the vehicle, and a steering angle of the vehicle.

In one example, the trailer load includes a longitudinal trailer load, a lateral trailer load, and a vertical trailer load.

In one example, the method includes measuring the wheel speed of the trailer, and determining the trailer width based on the trailer wheel speed using a kinematic model.

In one example, the method includes determining the trailer width further based on a turning radius of the trailer.

In one example, the method includes determining the trailer turning radius based on a wheelbase of the vehicle, a steering angle of the vehicle, the trailer hitching length, and the trailer drawbar length.

In one example, the method includes determining the hitch angle based on the input from the at least one of the rear camera of the vehicle and the hitch angle sensor, and determining the trailer drawbar length and the trailer hitching length based on the hitch angle using a kinematic model and linear regression.

In one example, the method includes determining the trailer drawbar length and the trailer hitching length further based on a speed of the vehicle, a first derivative of the hitch angle with respect to time, a wheelbase of the vehicle, and a steering angle of the vehicle.

In one example, the method further includes at least one of (i) controlling a steering actuator of the vehicle based on the trailer width and (ii) controlling a user interface device of the vehicle based on at least one of the trailer width, the trailer mass, the trailer drawbar length, the trailer height, and the trailer hitching length.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic of an example vehicle system including a vehicle, a trailer, and a vehicle control module according to the principles of the present disclosure;

FIG. 2 is a side view the trailer of FIG. 1;

FIG. 3 is a functional block diagram of the vehicle control module of FIG. 1;

FIG. 4 is a flowchart illustrating an example method of estimating trailer width and trailer mass according to the principles of the present disclosure;

FIG. 5 is a flowchart illustrating an example method of estimating drawbar length and hitch length according to the principles of the present disclosure;

FIG. 6 is another schematic of the example vehicle system of FIG. 1 illustrating additional parameters associated therewith;

FIG. 7 is a flowchart illustrating another method of estimating trailer width according to the principles of the present disclosure;

FIG. 8 is a schematic of the example vehicle system of FIG. 1 and a second vehicle with cameras generating images of a trailer according to the principles of the present disclosure; and

FIG. 9 is a flowchart illustrating an example method of estimating trailer dimensions using vehicle-to-vehicle (V2V) communication according to the principles of the present disclosure.

In the drawings, reference numbers may be reused to identify similar and/or identical elements.

### DETAILED DESCRIPTION

As discussed above, driver assistance systems and autonomous driving systems use various dimensions of a trailer and a vehicle towing the trailer when providing assistance to a driver of a vehicle towing the trailer or autonomously driving the vehicle. These dimensions include trailer width, trailer drawbar length, trailer total length, trailer height, trailer mass, and trailer hitching length. These dimensions are typically obtained through manual user input, which is inefficient, subject to human error, and may dissatisfy vehicle users.

To address this issue, a system and method according to the present disclosure automatically determines trailer dimensions using mathematical models (e.g., kinematic models, static models, dynamic models) of the vehicle and the trailer. In one example, the system and method estimates the width of the trailer and a mass of the trailer based on loads applied to a trailer hitch of a vehicle by the trailer using a mathematic model of the vehicle and the trailer and non-linear regression. In another example, the system and method estimates the drawbar length of a trailer and a trailer hitching length of a vehicle using a kinematic model of the vehicle and the trailer and linear regression.

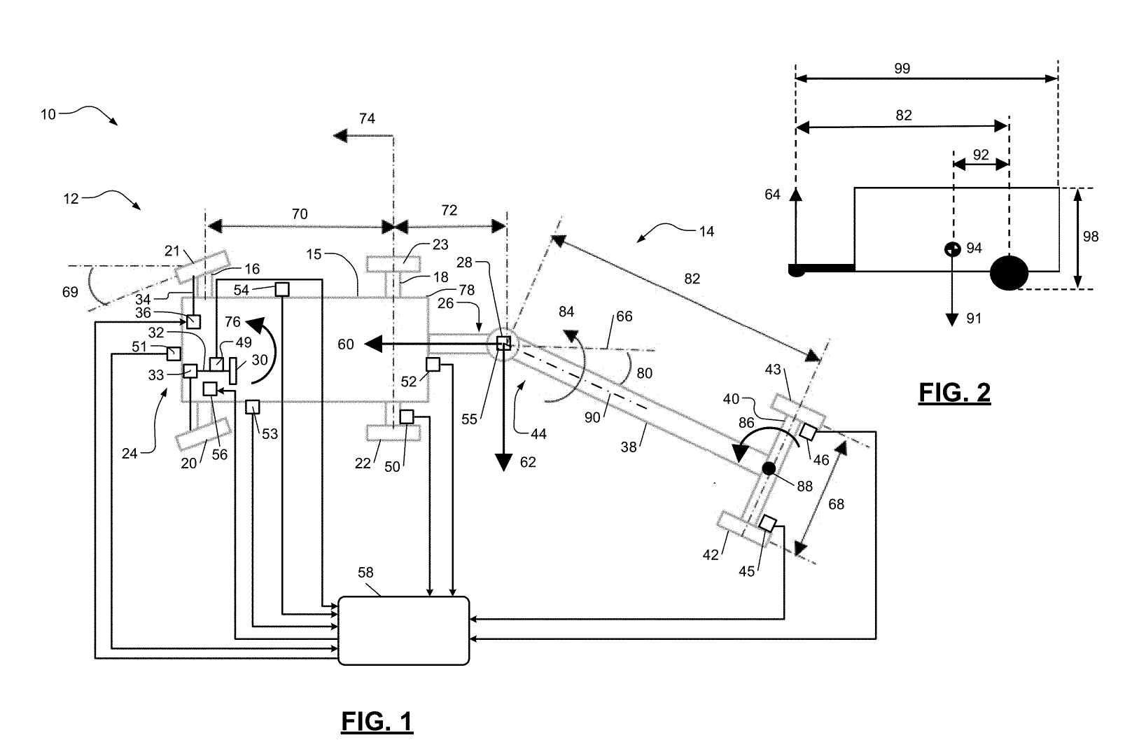

Referring now to FIGS. 1, 2, 6, and 8, a vehicle system 10 includes a vehicle 12 and a trailer 14. The vehicle 12 includes a frame or body 15, a front axle 16, a rear axle 18, a left front wheel 20, a right front wheel 21, a left rear wheel 22, a right rear wheel 23, a steering system 24, and a trailer hitch 26 having a distal end or ball 28. The steering system 24 is operable to turn the left and right front wheels 20 and 21 and thereby turn the vehicle 12.

The steering system 24 includes a steering wheel 30, a steering column 32, a steering gear 33, a steering linkage 34, and a steering actuator 36. A driver rotates the steering wheel 30 to turn the vehicle 12 left or right. The steering column 32 is coupled to the steering wheel 30 so that the steering column 32 rotates when the steering wheel 30 is rotated. The steering gear 33 couples the steering column 32 to the steering linkage 34 so that rotation of the steering column 32 causes translation of the steering linkage 34. The steering linkage 34 is coupled to the left and right front wheels 20 and 21 so that translation of the steering linkage 34 turns the left and right front wheels 20 and 21.

The steering actuator 36 is coupled to the steering linkage 34 and is operable to translate the steering linkage 34 and thereby turn the left and right front wheels 20 and 21. The steering actuator 36 may be a hydraulic and/or electric actuator. If the steering column 32 is coupled to the steering linkage 34 as shown in FIG. 1, the steering actuator 36 may reduce the amount of effort that the driver must exert to turn the vehicle 12 left or right. In various implementations, the steering column 32 may not be coupled to the steering linkage 34 (i.e., the steering gear 33 may be omitted), and the steering actuator 36 may translate the steering linkage 34 in response to an electronic signal that is generated based on the position of the steering wheel 30. When the steering actuator 36 is electronically controlled in this way, the steering system 24 may be referred to as a steer-by-wire system.

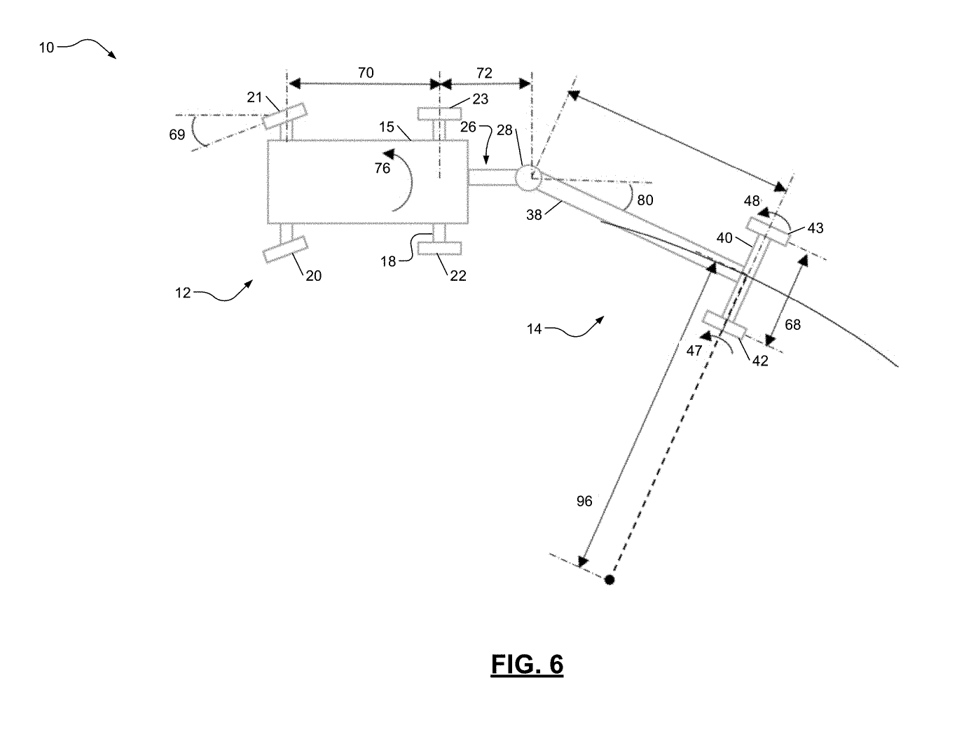

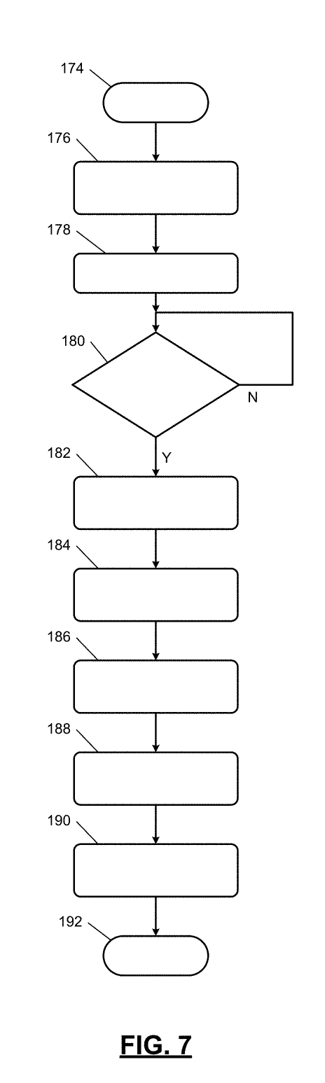

The trailer 14 includes a frame or body 38, an axle 40, a left wheel 42, a right wheel 43, a tongue 44, a left wheel speed sensor 45, and a right wheel speed sensor 46. The tongue 44 of the trailer 14 may be placed onto the ball 28 of the trailer hitch 26 of the vehicle 12 to couple the trailer 14 to the vehicle 12. The left wheel speed sensor 45 measures a rotational speed 47 (FIG. 6) of the left wheel 42 of the trailer 14. The right wheel speed sensor 46 measures a rotational speed 48 (FIG. 6) of the right wheel 43 of the trailer 14.

The vehicle 12 further includes a steering wheel position sensor 49, a wheel speed sensor 50, a front camera 51, a rear camera 52, a left side camera 53, a right side camera 54, a trailer load sensor 55, a user interface device 56, and a vehicle control module 58. The steering wheel position sensor 49 measures the angular position of the steering wheel 30. The steering wheel position sensor 49 may include a magnet mounted to the steering column 32 and a Hall effect sensor that detects the intensity of a magnetic field generated by the magnet.

The wheel speed sensor 50 measures the speed of the left rear wheel 22 of the vehicle 12. Although the wheel speed sensor 50 is shown mounted to the left rear wheel 22, the wheel speed sensor 50 may measure the speed of another wheel of the vehicle 12. In various implementations, the vehicle 12 may include multiple wheel speed sensors to measure the speeds of multiple wheels of the vehicle.

The front camera 51 captures an image of the environment in front of the vehicle 12. The rear camera 52 captures an image of the environment to the rear of the vehicle 12. The left side camera 53 captures an image of the environment on the left side of the vehicle 12. The right side camera 54 captures an image of the environment on the right side of the vehicle 12.

The trailer load sensor 55 measures one or more loads applied by the trailer 14 on the trailer hitch 26 of the vehicle 12. The trailer loads measured by the trailer load sensor 55 may include a longitudinal trailer load 60, a lateral trailer load 62, and a vertical trailer load 64 (FIG. 2). The longitudinal trailer load 60 is applied in a fore-aft or longitudinal direction of the vehicle 12 along a longitudinal axis 66 thereof. The lateral trailer load 62 is applied in a side-to-side or lateral direction of the vehicle 12. The vertical trailer load 64 is applied in a vertical direction of the vehicle 12.

The user interface device 56 may include an electronic display (e.g., a touch display) and/or one or more speakers. The electronic display may display the images captured by the cameras 51-54. Additionally or alternatively, the electronic display may display a top view image of the trailer 14, text and/or graphics indicating the width of the trailer 14, an expected trajectory of the trailer 14 when the trailer 14 is travelling in reverse, and/or the location of a load in the trailer 14. The speakers may produce an audible message indicating when a load in the trailer 14 has shifted.

The vehicle control module 58 determines one or more dimensions of the trailer 14 based on an input from one or more of the aforementioned sensors and controls the operation of the steering actuator 36 and/or the user interface device 56 based thereon. In one example, the vehicle control module 58 estimates a width 68 of the trailer 14 and a mass of the trailer 14 based on the longitudinal trailer load 60, the lateral trailer load 62, and the vertical trailer load 64 using a mathematical model and non-linear regression. The vehicle control module 58 also controls the steering actuator 36 and the user interface device 56 based on the estimated trailer dimensions. In another example, the vehicle control module 58 performs autonomous steering by controlling the steering actuator 36 based on the estimated trailer width 68 and independent of driver input.

The vehicle control module 58 may use one or more parameters associated with the vehicle 12 when estimating the dimension(s) of the trailer 14. For example, the vehicle control module 58 may estimate the trailer dimension(s) based on a steering angle 69 of the vehicle 12, a wheelbase 70 of the vehicle 12, a trailer hitching length 72, a linear speed 74 of the vehicle 12, and/or an angular velocity 76 of the vehicle 12. The steering angle 69 is the angle between the longitudinal axis 66 of the vehicle 12 and a steered wheel of the vehicle 12. The steering angle 69 may be a first angle between the vehicle longitudinal axis 66 and the right front wheel 21 (as shown in FIG. 1), a second angle between the vehicle longitudinal axis 66 and the left front wheel 20, or an average of the first and second angles.

The vehicle wheelbase 70 extends from the front axle 16 of the vehicle 12 to the rear axle 18 of the vehicle 12. The trailer hitching length 72 extends from the rear axle 18 of the vehicle 12 to the trailer hitch ball 28. Thus, the trailer hitching length 72 includes the length of the trailer hitch 26 (i.e., the distance from a rear end 78 of the vehicle 12 to the ball 28 of the trailer hitch 26) and the distance from the rear axle 18 to the vehicle rear end 78.

The vehicle control module 58 may also use one or more parameters associated with the trailer 14 when estimating the trailer dimension(s). For example, the vehicle control module 58 may estimate the trailer dimension(s) based on a hitch angle 80, a drawbar length 82 of the trailer 14, an angular velocity 84 of the trailer 14, and/or a yaw moment 86 of the trailer 14 about a mass center 88 of the trailer 14. The hitch angle 80 is the between the longitudinal axis 66 of the vehicle 12 and a longitudinal axis 90 of the trailer 14. The trailer drawbar length 82 extends from the distal end of the tongue 44 of the trailer 14 to the axle 40 of the trailer 14.

The vehicle control module 58 may also estimate the trailer dimension(s) based on a weight 91 of the trailer 14, a distance 92 (FIG. 2) from a center of gravity 94 of the trailer 14 to the axle 40 of the trailer 14, the trailer left wheel speed 47 (FIG. 6), the trailer right wheel speed 48 (FIG. 6), and/or a turning radius 96 (FIG. 6) of the trailer 14. Although the mass center 88 of the trailer 14 is shown at one location in FIG. 1 and the center of gravity 94 of the trailer 14 is shown at another location in FIG. 2, the mass center 88 and the center of gravity 94 may be at the same location.

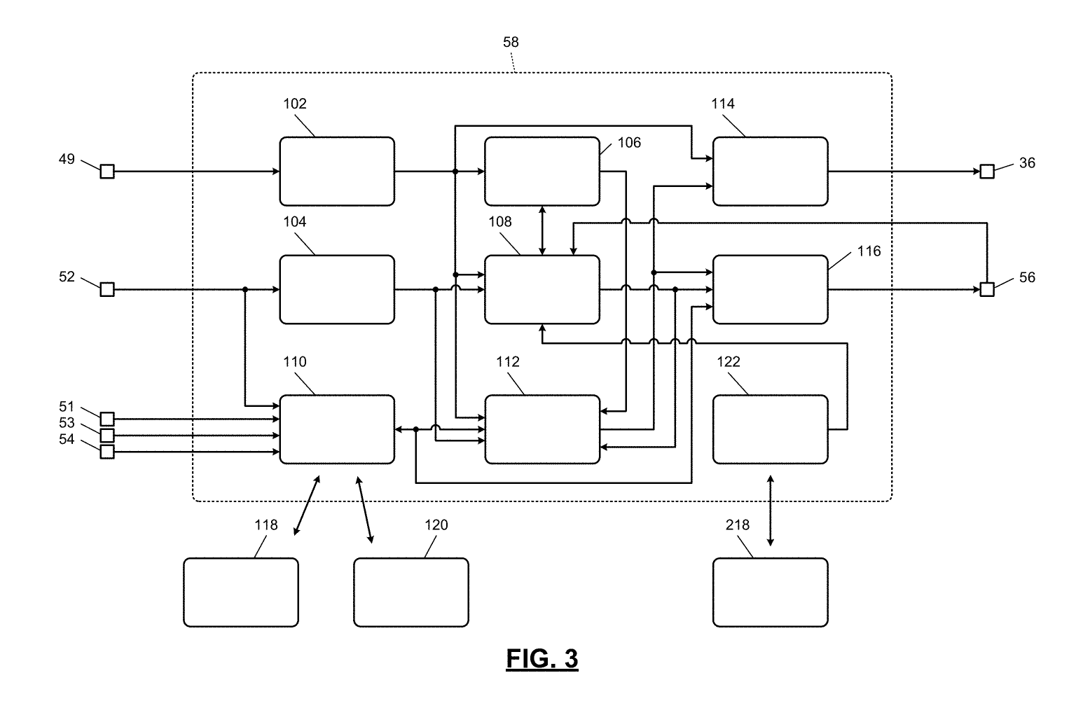

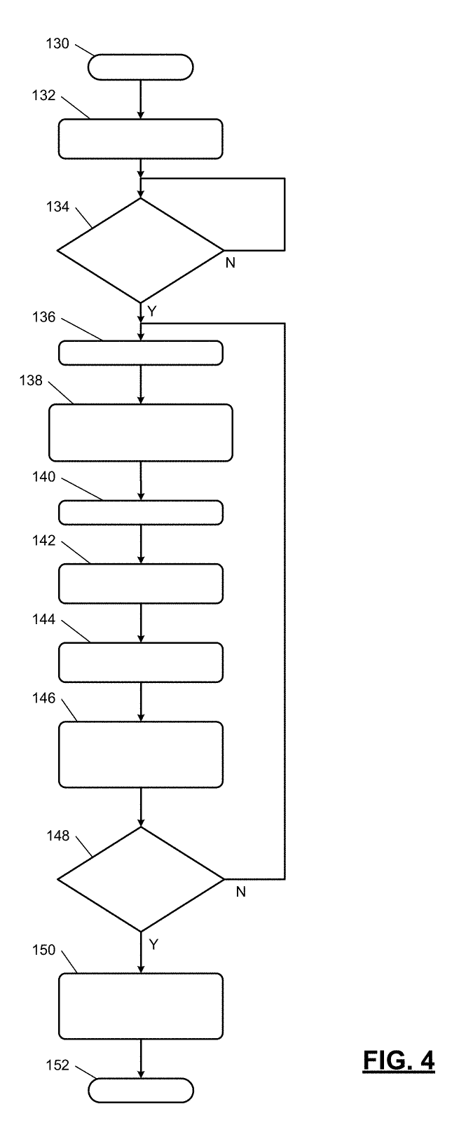

Referring now to FIG. 3, an example implementation of the vehicle control module 58 includes a steering angle module 102, a hitch angle module 104, a trailer turning radius module 106, and a trailer dimension module 108. The steering angle module 102 determines the steering angle 69 of the vehicle 12. The steering angle module 102 may determine the steering angle 69 based on the steering wheel position from the steering wheel position sensor 49 using, for example, a function or mapping. The steering angle module 102 outputs the steering angle 69.

The hitch angle module 104 determines the hitch angle 80. The hitch angle module 104 may determine the hitch angle 80 based on an input from the rear camera 52 (e.g., the image of the environment to the rear of the vehicle 12). Additionally or alternatively, the hitch angle module 104 may determine the hitch angle 80 based on an input from a Hall effect or ultrasonic sensor (not shown) that outputs a voltage indicating the hitch angle 80. The hitch angle module 104 outputs the hitch angle 80.

The trailer turning radius module 106 determines the turning radius 96 of the trailer 14. The trailer turning radius module 106 may determine the trailer turning radius 96 based on the vehicle wheelbase 70, the steering angle 69, the trailer hitching length 72, and the trailer drawbar length 82. For example, the trailer turning radius module 106 may determine the trailer turning radius 96 using a relationship such as

Rₜ=\sqrt{l_{N}(cot δ)²+lₕ²−lₜᵣ²} (1)

where Rₜ is the trailer turning radius 96, l_{w} is the vehicle wheelbase 70, b is the steering angle 69, lₕ is the trailer hitching length 72, and lₜᵣ is the trailer drawbar length 82. The vehicle wheelbase 70 may be predetermined. The hitching and drawbar lengths 72 and 82 may be estimated or input by a user via the user interface device 56. The trailer turning radius module 106 outputs the turning radius 96.

The trailer dimension module 108 estimates one or more dimensions of the trailer 14 and/or the trailer hitching length 72. The trailer dimension(s) estimated by the trailer dimension module 108 may include the trailer width 68, the mass of the trailer 14 (i.e., the trailer weight 91 divided by gravitational acceleration), a height 98 (FIG. 2) of the trailer 14, and/or a total length 99 (FIG. 2) of the trailer 14. The trailer dimension module 108 outputs the trailer width 68, the trailer hitching length 72, the trailer mass, the trailer height 98, and/or the trailer total length 99.

The example implementation of the vehicle control module 58 shown in FIG. 3 further includes an environment mapping module 110, an expected trajectory module 112, a steering control module 114 and a user interface device (UID) control module 116. The environment mapping module 110 determines lane boundaries of a road on which the vehicle 12 is travelling, the position of the vehicle 12 on the road, and/or whether any obstacles lie in expected trajectories of the vehicle 12 and the trailer 14. The lane boundaries determined by the environment mapping module 110 may include an outer lane boundary and an inner lane boundary. The outer lane boundary may be a curb or a lane marking. The inner lane boundary may be a centerline (i.e., a lane marking) of the road on which the vehicle 12 is travelling.

The environment mapping module 110 may determine the lane boundaries based on the image captured by the front camera 51. Additionally or alternatively, the environment mapping module 110 may receive the lane boundaries from a vehicle-to-everything (V2X) communication network 118 and/or a satellite communication network 120. The environment mapping module 110 may also determine the position of the vehicle 12 by communicating with the V2X communication network 118 and/or the satellite communication network 120. The environment mapping module 110 may include an antenna, a transceiver, and/or a global positioning system (GPS) for wirelessly communicating with the V2X communication network 118 and/or the satellite communication network 120.

The environment mapping module 110 may determine whether any obstacles lie in the expected trajectories of the vehicle 12 and the trailer 14 based on the expected trajectories of the vehicle 12 and the trailer 14 and the image captured by the front camera 51. Additionally or alternatively, the environment mapping module 110 may determine whether any obstacles lie in the expected trajectory of the vehicle 12 by communicating with the V2X communication network 118 and/or the satellite communication network 120. The environment mapping module 110 may receive the expected trajectories of the vehicle 12 and the trailer 14 from the expected trajectory module 112. The environment mapping module 110 outputs the lane boundaries, the vehicle position, and/or the location of any obstacles that lie in the expected trajectory of the vehicle 12.

In addition, the environment mapping module 110 may generate a top view image of the vehicle 12 and at least part of the trailer 14 based on the images from the cameras 51-54, one or more parameters of the vehicle 12, and/or one or more parameters of the trailer 14. The vehicle parameter(s) may include the vehicle wheelbase 70 and/or the trailer hitching length 72. The trailer parameter(s) may include the trailer width 68 and/or the trailer drawbar length 82. The top view image generated by the environment mapping module 110 may include the lane boundaries of the road on which the vehicle 12 and the trailer 14 are travelling and/or any obstacles that lie within the expected trajectories of the vehicle 12 and the trailer 14.

The expected trajectory module 112 determines the expected trajectories of the vehicle 12 and the trailer 14. The expected trajectory module 112 may determine the expected trajectories of the vehicle 12 and the trailer 14 when the vehicle 12 and the trailer 14 are moving forward. The expected trajectory module 112 may also determine the expected trajectories of the vehicle 12 and the trailer 14 when the vehicle 12 and the trailer 14 are moving rearward. The expected trajectory module 112 outputs the expected trajectories of the vehicle 12 and the trailer 14.

The expected vehicle trajectory may include one or more points and/or a curve representing a path through which one or more points on the vehicle 12 are expected to move. For example, the expected vehicle trajectory may include two curves representing the paths through which the left and right front wheels 20 and 21 are expected to move. In another example, the expected vehicle trajectory may include four curves representing the paths through which the four corners of the vehicle 12 are expected to move.

Similarly, the expected trailer trajectory may include one or more points and/or a curve representing a path through which the trailer 14 is expected to move. For example, the expected trailer trajectory may include two curves representing the paths through which the left and right wheels 42 and 43 are expected to move. In another example, the expected trailer trajectory may include four curves representing the paths through which the four corners of the trailer 14 are expected to move.

The expected trajectory module 112 may determine the expected vehicle trajectory based on the steering angle 69 of the vehicle 12 and/or one or more parameters of the vehicle 12 using a function and/or a mapping. The expected trajectory module 112 may receive the steering angle 69 from the steering angle module 102. The vehicle parameters may include the position of the vehicle 12, the speed 74 of the vehicle 12, the wheelbase 70 of the vehicle 12, a wheel track of the vehicle 12, and/or a first distance from a mass center of the vehicle 12 to the rear axle 18. The expected trajectory module 112 may receive the vehicle position from the environment mapping module 110. The expected trajectory module 112 may determine the vehicle speed 74 based on the wheel speed from the wheel speed sensor 50. The vehicle wheelbase 70, the vehicle wheel track, and the first distance may be predetermined.

The expected trajectory module 112 may determine the expected trailer trajectory based on the steering angle of the vehicle 12, the hitch angle 80, one or more parameters of the vehicle 12, and/or one or more parameters of the trailer 14. The vehicle parameters may include the wheelbase 70 of the vehicle 12, the wheel track of the vehicle 12, the position of the vehicle 12, the speed of the vehicle 12, and/or the trailer hitching length 72. The trailer parameters may include the width 68 of the trailer 14 and/or the drawbar length 82 of the trailer 14. The trailer hitching length 72, the trailer width 68, and/or the trailer drawbar length 82 may be predetermined and/or estimated.

The steering control module 114 autonomously steers the vehicle 12 by controlling the steering actuator 36 to adjust the steering angle 69 based on an input from one or more sensors on the vehicle 12 and/or the trailer 14 and independent of driver input. The sensors used by the steering control module 114 to control the steering actuator 36 may include one or more cameras and/or ultrasonic sensors mounted to the front, rear, and/or sides of the vehicle 12 (e.g., cameras 51-54), the left wheel speed sensor 45 of the trailer 14, and/or the right wheel speed sensor 46 of the trailer 14.

In one example, the steering control module 114 adjusts the steering angle 69 to maintain the vehicle 12 and the trailer 14 within the lane boundaries of the road on which the vehicle 12 and the trailer 14 are travelling. In other words, the steering control module 114 adjusts the steering angle 69 to ensure that the expected trajectories of the vehicle 12 and the trailer 14 are within the lane boundaries of the read. The steering control module 114 may receive the lane boundaries of the road from the environment mapping module 110. The steering control module 114 may receive the expected trajectories of the vehicle 12 and the trailer 14 from the expected trajectory module 112.

In another example, if any obstacles lie in the expected trajectory of the vehicle 12 or the trailer 14, the steering control module 114 adjusts the steering angle 69 to prevent an impact with the obstacle(s). The steering control module 114 may receive a signal from the environment mapping module 110 indicating whether any obstacles lie in the expected trajectory of the vehicle 12 or the trailer 14. The steering control module 114 may maintain the vehicle 12 and the trailer 14 within the lane boundaries when adjusting the steering angle 69 to avoid obstacles.

The steering control module 114 may determine a desired steering angle and control the steering actuator 36 to minimize a difference between the desired steering angle and the steering angle 69. For example, the steering control module 114 may output a desired actuator position to control the steering actuator 36 and, in response, the steering actuator 36 may move to the desired actuator position. The steering control module 114 may determine the desired actuator position based on a function or mapping that relates desired steering angle to desired actuator position.

The UID control module 116 controls the user interface device 56 to display one or more of the images captured by the cameras 51-54, the top view image generated by the environment mapping module 110, and/or the expected trajectories of the vehicle 12 and the trailer 14. Additionally or alternatively, the UID control module 116 may control the user interface device 56 to display text and/or graphics indicating the width 68 of the trailer 14 and/or the location of a load in the trailer 14. Additionally or alternatively, the UID control module 116 may control the user interface device 56 to produce an audible message indicating when a load in the trailer 14 has shifted.

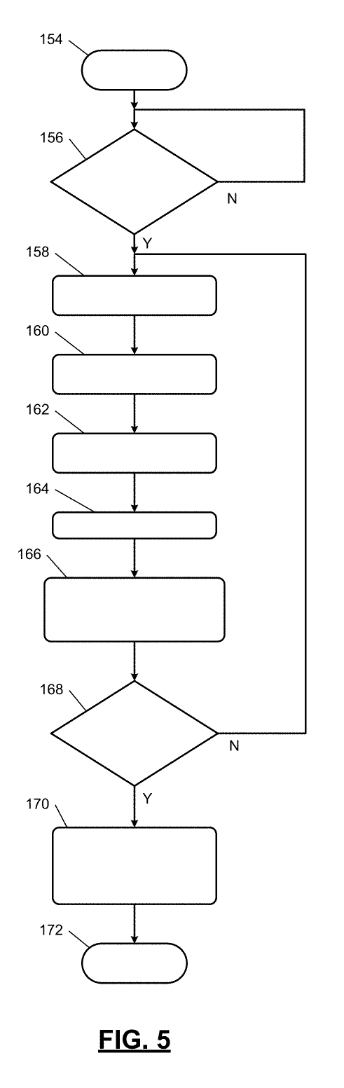

Referring now to FIG. 4, an example method of determining the trailer width 68 and the mass of the trailer 14 begins at 130. The method of FIG. 4 is described in the context of the vehicle system 10 as shown in FIGS. 1 and 2 and the modules of FIG. 3. However, the method of FIG. 4 may be performed with a different vehicle system. In addition, the particular modules that perform the steps of the method of FIG. 4 may be different than the modules mentioned below, or the method of FIG. 4 may be implemented apart from the modules of FIG. 3.

At 132, the trailer dimension module 108 obtains the trailer drawbar length 82. In one example, a user of the vehicle 12 inputs the trailer drawbar length 82 via the user interface device 56, and the trailer dimension module 108 receives the trailer drawbar length 82 from the user interface device 56. In another example, the trailer dimension module 108 estimates the trailer drawbar length 82 using the method described below with reference to FIG. 5.

At 134, the trailer dimension module 108 determines whether the vehicle 12 is moving while towing a trailer (e.g., the trailer 14). If the vehicle 12 is moving while towing a trailer, the method continues at 136. Otherwise, the method stays at 134 and continues to determine whether the vehicle 12 is moving while towing a trailer.

The trailer dimension module 108 may determine whether the vehicle 12 is moving based on the wheel speed from the wheel speed sensor 50. For example, the trailer dimension module 108 may determine the vehicle speed 74 based on the wheel speed from the wheel speed sensor 50, and determine that the vehicle 12 is moving when the vehicle speed is greater than a predetermined speed (e.g., zero). The trailer dimension module 108 may determine whether the vehicle 12 is towing a trailer based on the trailer loads measured by the trailer load sensor 55. For example, the trailer dimension module 108 may determine that the vehicle 12 is towing a trailer when the longitudinal trailer load 60, the lateral trailer load 62, and/or the vertical trailer load 64 is/are greater than a predetermined load.

At 136, the hitch angle module 104 determines the hitch angle 80. At 138, the trailer dimension module 108 determines the second derivative of the hitch angle 80 with respect to time. At 140, the trailer load sensor 55 measures the longitudinal trailer load 60, the lateral trailer load 62, and/or the vertical trailer load 64. At 142, the steering wheel position sensor 49 measures the position of the steering wheel 30. At 144, the steering angle module 102 determines the steering angle 69 of the vehicle 12 based on the steering wheel position.

At 146, the trailer dimension module 108 determines the longitudinal acceleration of the vehicle 12 (i.e., the acceleration of the vehicle 12 in the direction of the vehicle longitudinal axis 66). The trailer dimension module 108 may determine the first derivative of the vehicle speed 74 with respect to time in order to obtain the vehicle longitudinal acceleration. The trailer dimension module 108 may determine the vehicle speed 74 based on the wheel speed from the wheel speed sensor 50.

At 148, the trailer dimension module 108 determines whether the driving period of the vehicle 12 is greater than a threshold (e.g., a predetermined period). The driving period of the vehicle 12 may start when the vehicle 12 first starts moving while towing a trailer. The driving period of the vehicle 12 may end when the vehicle 12 stops moving. If the driving period of the vehicle 12 is greater than the threshold, the method continues at 150. Otherwise, the method continues at 136.

At 150, the trailer dimension module 108 estimates the trailer width 68 and the mass of the trailer 14 based on the longitudinal trailer load 60, the lateral trailer load 62, and the vertical trailer load 64 using non-linear regression and a mathematical model of the vehicle 12 and the trailer 14. For example, the trailer dimension module 108 may estimate the trailer width 68 and the trailer mass using mathematical models of the vehicle 12 and the trailer 14 such as

M_{Y}=(Fₓ sin θ−F_{y} cos θ)lₜᵣ=I_{Y}\dot{Ω}, and (2)

M_{P}=F_{Z}lₜᵣ=mₜgl_{cg} (3)

where M_{Y} is the yaw moment 86 of the trailer 14, M_{P} is the pitch moment of the trailer 14, Fₓ is the longitudinal trailer load 60, F_{y} is the lateral trailer load 62, F_{z} is the vertical trailer load 64, lₜᵣ is the trailer drawbar length 82, θ is the hitch angle 80, mₜ is the trailer mass, I_{Y} is the yaw moment of inertia of the trailer 14 about the mass center 88 of the trailer 14, \dot{Ω} is the angular acceleration of the trailer 14, g is gravitational acceleration, and l_{cg} is the distance 92 from the trailer center of gravity 94 of the trailer 14 to the trailer axle 40.

The angular acceleration of the trailer 14 may be determined using a relationship such as

$$\dot{Ω} = \ddot{θ} + \dot{ω} = \ddot{θ} + \frac{{a}_{x}}{{l}_{w}} tan δ \qquad ( 4 )$$

where \dot{Ω} is the angular acceleration of the trailer 14, \ddot{θ} is the second derivative of the hitch angle 80 with respect to time, \dot{ω} is the angular acceleration of the vehicle 12, αₓ is the longitudinal acceleration of the vehicle 12, l_{w} is the vehicle wheelbase 70, and δ is the steering angle 69.

The yaw moment of inertia of the trailer 14 may be determined using a relationship such as

I_{Y}= 1/12mₜ(lₜᵣ²+l_{wt}²+12l_{cg}²) (5)

where I_{Y} is the yaw moment of inertia of the trailer 14, mₜ is the trailer mass, lₜᵣ is the trailer drawbar length 82, l_{wt} is the trailer width 68, and l_{cg} is the distance 92 from the trailer center of gravity 94 of the trailer 14 to the trailer axle 40.

Relationships (3), (4), and (5) may be combined with relationship (2) to yield a single relationship that may be used along with non-linear regression to estimate the trailer width 68 and the trailer mass. For example, relationship (3) may be rearranged to solve for the distance 92, and l_{cg} in relationship (5) may be replaced with the portion of relationship (3) that is equal to the distance 92. \dot{Ω} and I_{Y} in relationship (2) may then be replaced with the right-hand sides of relationships (4) and (5), respectively, to yield the following relationship

$${( \frac{{F}_{Z} {l}_{tr}}{g} )}^{2} = - \frac{1}{12} {l}_{tr} {m}_{t}^{2} + [ \frac{( {F}_{x} sin θ - {F}_{y} cos θ ) {l}_{tr}}{\ddot{θ} + \frac{{a}_{x}}{{l}_{w}} tan δ} ] {m}_{t} + - \frac{1}{12} {m}_{t} {l}_{wt}^{2} \qquad ( 6 )$$

where l_{wt} is the trailer width 68, mₜ is the trailer mass, Fₓ is the longitudinal trailer load 60, F_{y} is the lateral trailer load 62, F_{z} is the vertical trailer load 64, lₜᵣ is the trailer drawbar length 82, g is gravitational acceleration, θ is the hitch angle 80, \ddot{θ} is the second derivative of the hitch angle 80 with respect to time, αₓ is the vehicle longitudinal acceleration, l_{w} is the vehicle wheelbase 70, and δ is the steering angle 69.

The trailer dimension module 108 may use relationship (6) and non-linear regression to estimate the trailer width 68 and the trailer mass. The trailer dimension module 108 may use a plurality of data sets when using relationship (6) and non-linear regression to estimate the trailer width 68 and the trailer mass. Each data set may include a value for each of the lateral trailer load 62, the vertical trailer load 64, the hitch angle 80, the second derivative of the hitch angle 80 with respect to time, and the vehicle longitudinal acceleration. The number of data sets available to estimate the trailer width 68 and the trailer mass depends on the duration of the driving period during which the data sets are obtained and the rate at which the values in the data sets are determined or measured. Thus, the driving period threshold may be selected based on the number of data sets needed to estimate the trailer width 68 and the trailer mass using relationship (6) and non-linear regression. After estimating the trailer width 68 and the trailer mass, the method ends at 152.

Referring now to FIG. 5, an example method of estimating the trailer hitching length 72 and the trailer drawbar length 82 begins at 154. The method of FIG. 5 is described in the context of the vehicle system 10 as shown in FIGS. 1 and 2 and the modules of FIG. 3. However, the method of FIG. 5 may be performed with a different vehicle system. In addition, the particular modules that perform the steps of the method of FIG. 5 may be different than the modules mentioned below, or the method of FIG. 5 may be implemented apart from the modules of FIG. 3.

At 156, the trailer dimension module 108 determines whether the vehicle 12 is moving while towing a trailer (e.g., the trailer 14). If the vehicle 12 is moving while towing a trailer, the method continues at 158. Otherwise, the method stays at 156 and continues to determine whether the vehicle 12 is moving while towing a trailer.

The trailer dimension module 108 may determine whether the vehicle 12 is moving based on the wheel speed from the wheel speed sensor 50. For example, the trailer dimension module 108 may determine the vehicle speed 74 based on the wheel speed from the wheel speed sensor 50, and determine that the vehicle 12 is moving when the vehicle speed is greater than a predetermined speed (e.g., zero). The trailer dimension module 108 may determine whether the vehicle 12 is towing a trailer based on the trailer loads measured by the trailer load sensor 55. For example, the trailer dimension module 108 may determine that the vehicle 12 is towing a trailer when the longitudinal trailer load 60, the lateral trailer load 62, and/or the vertical trailer load 64 is/are greater than a predetermined load.

At 158, the trailer dimension module 108 determines the vehicle speed 74. The trailer dimension module 108 may determine the vehicle speed 74 based on the wheel speed from the wheel speed sensor 50. At 160, the steering wheel position sensor 49 measures the position of the steering wheel 30. At 162, the steering angle module 102 determines the steering angle 69 of the vehicle 12 based on the steering wheel position. At 164, the hitch angle module 104 determines the hitch angle 80. At 166, the trailer dimension module 108 determines the first derivative of the hitch angle 80 with respect to time.

At 168, the trailer dimension module 108 determines whether the driving period of the vehicle 12 is greater than a threshold (e.g., a predetermined period). The driving period of the vehicle 12 may start when the vehicle 12 first starts moving while towing a trailer. The driving period of the vehicle 12 may end when the vehicle 12 stops moving. If the driving period of the vehicle 12 is greater than the threshold, the method continues at 170. Otherwise, the method continues at 158.

At 170, the trailer dimension module 108 estimates the trailer hitching length 72 and the trailer drawbar length 82 based using linear regression and a kinematic model of the vehicle 12 and the trailer 14. For example, the trailer dimension module 108 may estimate the trailer hitching length 72 and the trailer drawbar length 82 using linear regression and a kinematic model of the vehicle 12 and the trailer 14 such as

$$\dot{θ} = Ω - ω = - \frac{{V}_{c}}{{l}_{tr}} sin θ - \frac{{V}_{c}}{{l}_{w}} tan δ ( \frac{{l}_{h}}{{l}_{tr}} cos θ + 1 ) \qquad ( 7 )$$

where \dot{θ} is the first derivative of the hitch angle 80 with respect to time, Ω is the angular velocity 84 of the trailer 14, ω is the angular velocity 76 of the vehicle 12, V_{C} is the speed 74 of the vehicle 12, lₜᵣ is the trailer drawbar length 82, θ is the hitch angle 80, l_{w} is the vehicle wheelbase 70, and δ is the steering angle 69.

Relationship (7) may be rearranged and a noise or estimation error term may be added to relationship (7) to yield the following relationship

$${y}_{i} = {x}_{i} β + {ɛ}_{i} , where {ɛ}_{i} is the error term , \\ β = [ \begin{matrix}{β}_{1} \\ {β}_{2}\end{matrix} ] = [ \begin{matrix}\frac{1}{{l}_{tr}} \\ \frac{{l}_{h}}{{l}_{tr}}\end{matrix} ] \\ {x}_{i} = [ {( - {V}_{c} sin θ )}_{i} {( - \frac{{V}_{c}}{{l}_{w}} tan δ cos θ )}_{i} ] , and \\ {y}_{i} = {( \dot{θ} + \frac{{V}_{c}}{{l}_{w}} tan δ )}_{i} . \qquad ( 8 )$$

The error term may be predetermined by using relationship (8) and linear regression to estimate the trailer hitching length 72 and the trailer drawbar length 82, determining the difference between the estimated values of the trailer hitching length 72 and the trailer drawbar length 82 to known values thereof, and adjusting the error term to minimize this difference (or reduce the difference to an acceptable value). The above method of determining the error term may be characterized as a trial-and-error method, and this method may be performed in a vehicle development setting.

The trailer dimension module 108 may use relationship (8) and linear regression to estimate the trailer hitching length 72 and the trailer drawbar length 82. The trailer dimension module 108 may use a plurality of data sets when using relationship (8) and linear regression to estimate the trailer hitching and drawbar lengths 82. Each data set may include a value for each of the vehicle speed 74, the hitch angle 80, steering angle 69, and the first derivative of the hitch angle 80 with respect to time. The number of data sets available to estimate the trailer hitching length 72 and the trailer drawbar length 82 depends on the duration of the driving period during which the data sets are obtained and the rate at which the values in the data sets are determined or measured. Thus, the driving period threshold may be selected based on the number of data sets needed to estimate the trailer hitching and drawbar lengths 72 and 82 using relationship (8) and linear regression.

The subscript i in relationship (8) represents the data set number. The error term may have a unique value for each data set (as indicated by the subscript i in the error term), or the error term may have the same value for all of the data sets. In either case, the error term may be determined using the trial-and-error method described above.

Relationship (8) may be rearranged to solve for the unknown term β, and relationship (8) may be rewritten in matrix form to yield the following relationship

$$β = [ \begin{matrix}{β}_{1} \\ {β}_{2}\end{matrix} ] = {( {X}^{T} X )}^{- 1} {X}^{T} Y , where \qquad ( 9 )$$

where X is a matrix of the xᵢ values, X^{T} is the transpose of the matrix X, and Y is a matrix of the yᵢ values. The trailer dimension module 108 may use relationship (9) and linear regression to estimate the trailer hitching length 72 and the trailer drawbar length 82. After estimating the trailer hitching length 72 and the trailer drawbar length 82, the method ends at 172.

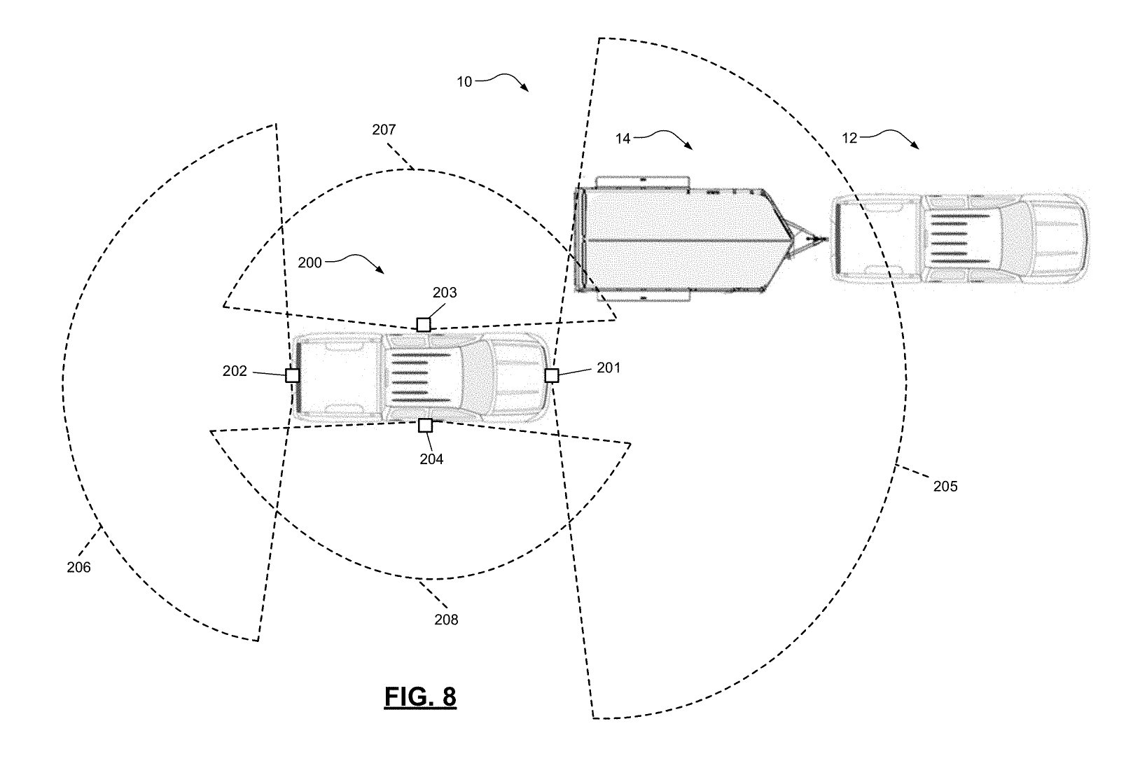

Referring now to FIG. 7, another example method of determining the trailer width 68 begins at 174. The method of FIG. 7 is described in the context of the vehicle system 10 as shown in FIG. 6 and the modules of FIG. 3. However, the method of FIG. 7 may be performed with a different vehicle system. In addition, the particular modules that perform the steps of the method of FIG. 7 may be different than the modules mentioned below, or the method of FIG. 7 may be implemented apart from the modules of FIG. 3.

At 176, the trailer dimension module 108 obtains the trailer hitching length 72. At 178, the trailer dimension module 108 obtains the trailer drawbar length 82. In one example, a user of the vehicle 12 inputs the trailer hitching length 72 and the trailer drawbar length 82 via the user interface device 56, and the trailer dimension module 108 receives the trailer hitching length 72 from the user interface device 56. In another example, the trailer dimension module 108 estimates the trailer hitching length 72 and the trailer drawbar length 82 using the method described above with reference to FIG. 5.

At 180, the trailer dimension module 108 determines whether the vehicle 12 is moving while towing a trailer (e.g., the trailer 14). If the vehicle 12 is moving while towing a trailer, the method continues at 182. Otherwise, the method stays at 180 and continues to determine whether the vehicle 12 is moving while towing a trailer.

The trailer dimension module 108 may determine whether the vehicle 12 is moving based on the wheel speed from the wheel speed sensor 50. For example, the trailer dimension module 108 may determine the vehicle speed 74 based on the wheel speed from the wheel speed sensor 50, and determine that the vehicle 12 is moving when the vehicle speed is greater than a predetermined speed (e.g., zero). The trailer dimension module 108 may determine whether the vehicle 12 is towing a trailer based on the trailer loads measured by the trailer load sensor 55. For example, the trailer dimension module 108 may determine that the vehicle 12 is towing a trailer when the longitudinal trailer load 60, the lateral trailer load 62, and/or the vertical trailer load 64 is/are greater than a predetermined load.

At 182, the left and right wheel speed sensors 45 and 46 of the trailer 14 measure the rotational speeds 47 and 48 of the left and right wheels 42 and 43, respectively. At 184, the steering wheel position sensor 49 measures the position of the steering wheel 30. At 186, the steering angle module 102 determines the steering angle 69 of the vehicle 12 based on the steering wheel position. At 188, the trailer turning radius module 106 determines the turning radius 96 of the trailer 14 using, for example, relationship (1) as described above with reference to FIG. 2.

At 190, the trailer dimension module 108 determines the trailer width 68 based on the left and right trailer wheel speeds 47 and 48 using a kinematic model of the vehicle 12 and the trailer 14 such as

$${l}_{wt} = 2 {R}_{t} ( \frac{{α}_{R} - {α}_{L}}{{α}_{R} + {α}_{L}} ) , where \qquad ( 10 )$$

where l_{wt} is the trailer width 68, Rₜ is the turning radius of the trailer 14, α_{L} is the left wheel speed 47 of the trailer 14, and α_{R} is the right wheel speed 48 of the trailer 14. The method ends at 192.

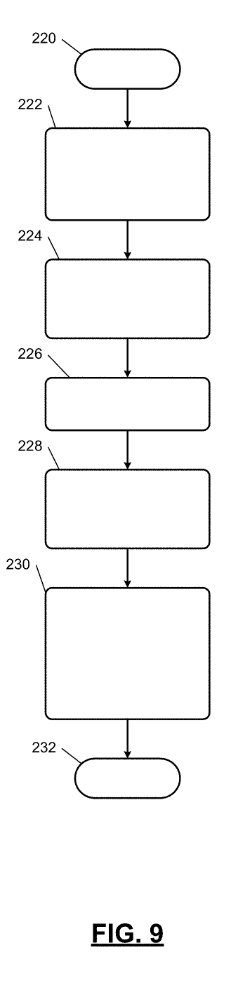

Referring now to FIG. 8, the vehicle system 10 is shown with a second vehicle 200 following the vehicle system 10 and disposed to the right of the vehicle system 10. The second vehicle 200 includes a front camera 201, a rear camera 202, a left side camera 203, and a right side camera 204. The front camera 201 has a first field of view 205 and captures an image of the environment in front of the vehicle 200. The rear camera 202 has a second field of view 206 and captures an image of the environment to the rear of the vehicle 200. The left side camera 203 has a third field of view 207 and captures an image of the environment on the left side of the vehicle 200. The right side camera 204 has a fourth field of view 208 and captures an image of the environment on the right side of the vehicle 200.

With additional reference to FIG. 2, the vehicle 12 of the vehicle system 10 may further include a vehicle-to-vehicle (V2V) transceiver 122, and the second vehicle 200 may further include a V2V transceiver 218. The V2V transceivers 122 and 210 communicate with one another using signals within a predetermined frequency band (e.g., between 5.855 and 5.905 gigahertz). The V2V transceiver 122 may be included in the vehicle control module 58 of the vehicle 12 as shown. Alternatively, the V2V transceiver 122 may be separate from the vehicle control module 58 and communicate with the vehicle control module 58 via wired or wireless communication. In various implementations, the V2V transceiver 122 may be a V2X transceiver that communicates with both the V2X communication network 118 and the V2V transceiver 218 of the second vehicle 200. In these implementations, the environment mapping module 110 may communicate with the V2X communication network 118 through the V2X transceiver 122 rather than directly communicating with the V2X communication network 118.

Referring now to FIG. 9, an example method of determining one or more dimensions of the trailer 14 using vehicle-to-vehicle (V2V) communication begins at 220. The method of FIG. 9 is described in the context of the vehicle system 10 as shown in FIG. 8, the second vehicle 200 of FIG. 8, and the modules of FIG. 3. However, the method of FIG. 8 may be performed with a different vehicle system. In addition, the particular modules that perform the steps of the method of FIG. 8 may be different than the modules mentioned below, or the method of FIG. 8 may be implemented apart from the modules of FIG. 3.

At 222, one or more of the cameras 201-204 of the second vehicle 200 generate one or more images of the trailer 14 (i.e., a trailer attached to a first vehicle adjacent to the second vehicle 200). At 224, the V2V transceiver 218 of the second vehicle 200 transmits the image(s) of the trailer 14 to the V2V transceiver 122 of the vehicle 12. In one example, the V2V transceiver 218 of the second vehicle 200 transmits the images captured by the front and left side cameras 201 and 203 since their respective fields of view 205 and 207 encompass the trailer 14.

At 226, the trailer dimension module 108 receives the image(s) of the trailer 14 from the V2V transceiver 122 and detects edges of the trailer 14 in the trailer image(s). In one example, the trailer dimension module 108 detects an edge of the trailer 14 at locations in an image where a change in the brightness, color, and/or contrast of the image is greater than a predetermined value. At 228, the trailer dimension module 108 determines the distance(s) between the trailer 14 and those of the cameras 201-204 that generated the images(s) transmitted to the V2V transceiver 122 of the vehicle 12. For example, the trailer dimension module 108 may determine a first distance between trailer 14 and the front camera 201 and determine a second distance between the trailer 14 and the left side camera 203.

The trailer dimension module 108 may determine the distances between the trailer 14 and the cameras 201-204 based on inputs from ultrasonic or radar sensors (not shown) mounted to the vehicle 200 adjacent to the cameras 201-204. Additionally or alternatively, the trailer dimension module 108 may determine the distances between the trailer 14 and the cameras 201-204 based on a comparison of the sizes of the tires on the trailer 14 in the images generated by the cameras 201-204 and standard trailer tire sizes. Additionally or alternatively, the trailer dimension module 108 may determine the distances between the trailer 14 and the cameras 201-204 by comparing images of the trailer 14 captured by two or more of the cameras 201-204.

At 230, the trailer dimension module 108 determines one or more dimensions of the trailer 14 based on the locations of the edges of the trailer 14 in the trailer image(s) and the distance between the trailer 14 and the corresponding one(s) of the cameras 201-204. The trailer dimensions determined by the trailer dimension module 108 may include the trailer width 68, the trailer height 98, and/or the trailer total length 99. In one example, the trailer dimension module 108 determines the trailer dimension(s) based on a predetermined relationship between the number of pixels representing an edge of the trailer 14 in an image and the length of the trailer edge. In addition, the trailer dimension module 108 selects the predetermined relationship from a plurality of predetermined relationships between number of pixels and edge length based on the distance between the trailer 14 and the one of the cameras 201-204 that captured the image. The method ends at 232.

The method described above includes the V2V transceiver 218 of the second vehicle 200 transmitting images of the trailer 14 to the V2V transceiver 122 of the vehicle 12, and the trailer dimension module 108 determining dimensions of the trailer 14 based on the trailer images. However, in various implementations, the second vehicle 200 may include the trailer dimension module 108, and the V2V transceiver 218 of the second vehicle 200 may transmit the trailer dimensions to the V2V transceiver 122 of the vehicle 12 rather than the trailer images.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A system comprising:
at least one of:
a hitch angle module configured to determine a hitch angle based on an input from at least one of a rear camera of a vehicle and a hitch angle sensor, wherein the hitch angle is an angle between a longitudinal centerline of a trailer and a longitudinal centerline of the vehicle;
a trailer load sensor configured to measure a load applied by the trailer on a trailer hitch of the vehicle; and
a trailer wheel speed sensor configured to measure a wheel speed of the trailer; and
a trailer dimension module configured to determine at least one of a width of the trailer, a mass of the trailer, a drawbar length of the trailer, a height of the trailer, and a trailer hitching length of the vehicle based on at least one of the hitch angle, the trailer load, and the trailer wheel speed, wherein the trailer hitching length is a distance from a rear axle of the vehicle to a distal end of the trailer hitch.

2. The system of claim 1 wherein:
the system includes the hitch angle module and the trailer load sensor; and
the trailer dimension module is configured to determine the trailer width and the trailer mass based on the hitch angle and the trailer load using a mathematical model and non-linear regression.

3. The system of claim 2 wherein the trailer dimension module is configured to determine the trailer width and the trailer mass further based on a second derivative of the hitch angle with respect to time, a longitudinal acceleration of the vehicle, a wheelbase of the vehicle, and a steering angle of the vehicle.

4. The system of claim 1 wherein:
the system includes the trailer wheel speed sensor; and
the trailer dimension module is configured to determine the trailer width based on the trailer wheel speed using a kinematic model.

5. The system of claim 4 further comprising a trailer turning radius module configured to determine a turning radius of the trailer based on a wheelbase of the vehicle, a steering angle of the vehicle, the trailer hitching length, and the trailer drawbar length, wherein the trailer dimension module is configured to determine the trailer width further based on the trailer turning radius.

6. The system of claim 1 wherein:
the system includes the hitch angle module; and
the trailer dimension module is configured to determine the trailer drawbar length and the trailer hitching length based on the hitch angle using a kinematic model and linear regression.

7. The system of claim 6 wherein the trailer dimension module is configured to determine the trailer drawbar length and the trailer hitching length further based on a speed of the vehicle, a first derivative of the hitch angle with respect to time, a wheelbase of the vehicle, and a steering angle of the vehicle.

8. The system of claim 1 further comprising at least one of:
a steering control module configured to control a steering actuator of the vehicle based on the trailer width; and
a user interface device (UID) control module configured to control a user interface device of the vehicle based on at least one of the trailer width, the trailer mass, the trailer drawbar length, the trailer height, and the trailer hitching length.

9. A system comprising:
a trailer dimension module configured to determine at least one of a width of a trailer towed by a first vehicle, a length of the trailer, and a height of the trailer based on an image of the trailer generated by a camera mounted to a second vehicle; and
a vehicle-to-vehicle (V2V) transceiver configured to transmit at least one of the trailer width, the trailer length, the trailer height, and the trailer image to the first vehicle.

10. The system of claim 9 wherein:
the trailer dimension module is located on the first vehicle; and
the V2V transceiver is configured to transmit the trailer image to the first vehicle.

11. A method comprising:
at least one of:
determining a hitch angle based on an input from at least one of a rear camera of a vehicle and a hitch angle sensor, wherein the hitch angle is an angle between a longitudinal centerline of a trailer and a longitudinal centerline of the vehicle;
measuring a load applied by the trailer on a trailer hitch of the vehicle; and
measuring a wheel speed of the trailer; and
determining at least one of a width of the trailer, a mass of the trailer, a drawbar length of the trailer, a height of the trailer, and a trailer hitching length of the vehicle based on at least one of the hitch angle, the trailer load, and the trailer wheel speed, wherein the trailer hitching length is a distance from a rear axle of the vehicle to a distal end of the trailer hitch.

12. The method of claim 11 further comprising:
determining the hitch angle based on the input from the at least one of the rear camera of the vehicle and the hitch angle sensor; and
determining the trailer width and the trailer mass based on the hitch angle and the trailer load using a mathematical model and non-linear regression.

13. The method of claim 12 further comprising determining the trailer width and the trailer mass further based on a second derivative of the hitch angle with respect to time, a longitudinal acceleration of the vehicle, a wheelbase of the vehicle, and a steering angle of the vehicle.

14. The method of claim 12 wherein the trailer load includes a longitudinal trailer load, a lateral trailer load, and a vertical trailer load.

15. The method of claim 11 further comprising:
measuring the wheel speed of the trailer; and
determining the trailer width based on the trailer wheel speed using a kinematic model.

16. The method of claim 15 further comprising determining the trailer width further based on a turning radius of the trailer.

17. The method of claim 16 further comprising determining the trailer turning radius based on a wheelbase of the vehicle, a steering angle of the vehicle, the trailer hitching length, and the trailer drawbar length.

18. The method of claim 11 further comprising:
determining the hitch angle based on the input from the at least one of the rear camera of the vehicle and the hitch angle sensor; and
determining the trailer drawbar length and the trailer hitching length based on the hitch angle using a kinematic model and linear regression.

19. The method of claim 18 further comprising determining the trailer drawbar length and the trailer hitching length further based on a speed of the vehicle, a first derivative of the hitch angle with respect to time, a wheelbase of the vehicle, and a steering angle of the vehicle.

20. The method of claim 11 further comprising at least one of:
controlling a steering actuator of the vehicle based on the trailer width; and
controlling a user interface device of the vehicle based on at least one of the trailer width, the trailer mass, the trailer drawbar length, the trailer height, and the trailer hitching length.
